(19) United States
(12) Patent Application Publication
(10) Pub. No.: US 2006/0216399 A1
(43) Pub. Date: Sep. 28, 2006

(54) Frozen food and method for producing the same

(76) Inventors: Hideo Morita, Otsu-shi (JP); Fumio Noda, Nanao-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/386,856

(22) Filed: Mar. 22, 2006

(30) Foreign Application Priority Data
Mar. 24, 2005 (JP) 2005-086388

(51) Int. Cl. A23L 1/325

(52) U.S. Cl. 426/643

(57) ABSTRACT

The subject of the present invention is to provide a frozen food, which is a novel frozen kneaded product having a soft texture and containing no preservatives and which can be suitably utilized as a food for a senior, and a method for producing the frozen food. The frozen food of the present invention is produced by: using at least one type of protein selected from the group consisting of animal proteins and vegetable proteins, as a main raw material; adding modified starch, saccharide and water to the main raw material; kneading and heating the resultant mixture to produce a kneaded product; and subjecting the kneaded product to a high-voltage electric-field brine-freezing treatment. The frozen food of the present invention, which has high resistance to freezing, can be preserved over a long period of time and contribute to the effective utilization of food resources.

### BACKGROUND OF THE INVENTION

1. Field of the Invention

The present invention relates to a frozen food having a soft texture produced by: using animal proteins, such as those contained in seafood and farmed-animal meat, and/or vegetable proteins such as soybean protein and wheat protein, as a main raw material; adding a given amount of a given modified starch, a given saccharide and water to the main raw material; adding a flavoring material thereto if required; kneading and heating the resultant mixture to produce a kneaded product; and subjecting the kneaded product to a high-voltage electric-field brine-freezing treatment, and a method for producing the frozen food.

2. Description of the Related Art

Examples of known kneaded products, which are produced using protein contained in seafood, farmed-animal meat, beans and cereals, as a main raw material, adding a given amount of modified starch, saccharide and water to the main raw materials, adding a flavoring material thereto if required, and kneading and heating the resultant mixture, include fish sausage, ham, tofu and raw wheat gluten cake.

The above-described foods tend to decay easily, and therefore a preservative is contained therein. If no preservative is contained therein, the shelf-life of such foods are extremely short, leading to harm to consumer health and a waste of food resources due to an increased amount of waste disposal. For this reason, foods are packed, heated and frozen, but in this case, the flavor and texture of food degenerates.

A softer texture as possible of the food is desirable due to aging, and for this reason, the amount of water to be contained in the foods is increased. When foods containing a large amount of water are frozen, denaturation occurs due to freezing, and the original texture of the foods is lost. This problem cannot be solved by conventional techniques.

### SUMMARY OF THE INVENTION

The present invention was aimed at in order to solve the above-described problem. The purpose of the present invention is to provide a frozen food having a soft texture, in which animal proteins and/or vegetable proteins are used as a main raw material, and a method for producing the frozen food.

That is, the purpose of the present invention is to provide a frozen food, which is a novel frozen kneaded product having a soft texture and containing no preservatives, which can be suitably utilized as a food for a senior, and a method for producing the frozen food. Another purpose of the present invention is to provide a frozen food having high resistance to freezing, which can be preserved over a long period of time and contribute to the effective utilization of food resources, and a method for producing the frozen food.

Generally, when a food is frozen, denaturation occurs due to freezing, and the original texture of the food is lost. In particular, this tendency increases in systems containing large amounts of water. The above-described problem was solved by the present invention, as a result of finding that no denaturation due to freezing occurs in food containing large amounts of water when using given modified starch and saccharide in combination with a high-voltage electric-field brine-freezing treatment.

That is, a frozen food of the present invention is produced by: using at least one type of protein selected from the group consisting of animal proteins and vegetable proteins, as a main raw material; adding modified starch, saccharide and water to the main raw material; kneading and heating the resultant mixture to produce a kneaded product; and subjecting the kneaded product to a high-voltage electric-field brine-freezing treatment, thereby accomplishing the above-described purpose.

In one embodiment of the present invention, the processed starch is at least one type of starch selected from the group consisting of esterified starch, etherified starch, crosslinked starch and oxidized starch.

In one embodiment of the present invention, the content of the modified starch is 5 to 10 wt % of the food.

In one embodiment of the present invention, the saccharide is at least one type of saccharide selected from the group consisting of sugar, trehalose, oligosaccharide, sugar alcohol, starch syrup and reduced starch syrup.

In one embodiment of the present invention, the content of the saccharide is 5 to 15 wt % of the food.

In one embodiment of the present invention, the amount of the water to be added is 40 to 70 wt % of the food.

In one embodiment of the present invention, the kneaded product further comprises a flavoring material.

A method for producing a frozen food of the present invention, wherein at least one type of protein selected from the group consisting of animal proteins and vegetable proteins is used as a main raw material, comprising the steps of: adding modified starch, saccharide and water to the main raw material to be kneaded; heating the kneaded mixture to obtain a kneaded product; and subjecting the kneaded product to a high-voltage electric-field brine-freezing treatment, thereby accomplishing the above-described purpose.

In one embodiment of the present invention, the high-voltage electric-field brine-freezing treatment is a treatment in which freezing is carried out to pass through a temperature range of 0 to −5° C. within 15 minutes and reach a temperature range of −20 to −50° C.

In the present invention, by subjecting a kneaded product to brine-freezing with a high-voltage electric field, the temperature of a frozen food, which drops during freezing, can pass through the maximum ice crystal generation range (0 to −5° C.) as fast as possible. Therefore, the growth of ice crystals, formed with water contained in a food material, can be inhibited, thereby preventing breakdown of the structure, and when defrosted, the original state of the food material before freezing can be retained.

In order to provide soft texture, particularly for seniors, the amount of water to be added to a food must be increased. According to the present invention, growth of ice crystals, formed with water contained in a food material can be inhibited, thereby preventing breakdown of the structure, as described above. Therefore, even in the case of a food containing a large amount of water, the original state of the food material before freezing can be retained when defrosted.

These and other advantages of the present invention will become apparent to those skilled in the art upon reading and understanding the following detailed description.

### DESCRIPTION OF THE PREFERRED EMBODIMENTS

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

Hereinafter, embodiments of the present invention will be explained in detail.

A frozen food of the present invention is obtained by: using animal proteins and/or vegetable proteins as a main raw material: adding a given amount of a given modified starch, a given saccharide and water to the main raw material; adding a flavoring material thereto if required; kneading and heating the resultant mixture to produce a kneaded product; and subjecting the kneaded product to a high-voltage electric-field brine-freezing treatment.

As animal proteins, paste or pieces of seafood such as walleye pollock, cod, Atka mackerel, white croaker, lizard fish, sardine, scallop and the like, the meat of farmed-animals such as pigs, cattle, birds, rabbits and the like, isolated proteins such as gelatin, collagen and the like can be suitably used. As vegetable proteins, soybean, wheat, isolated soybean protein or wheat-gluten can be suitably used. These raw materials can be used in combination.

In the frozen food of the present invention, modified starch and saccharide are used in combination in order to provide resistance to freezing and to improve the texture of the food.

Examples of modified starches include: esterified starch, which is obtained by esterifying a free hydroxyl group in glucose which is the monosaccharide that constitutes starch; etherified starch, which is obtained by substituting a hydrogen atom in a hydroxyl group with an alkyl group; crosslinked starch, which is obtained by binding the hydroxyl groups in starch; and oxidized starch, which is obtained by oxidizing a reducing terminal of starch sugar with an oxidant.

Examples of suitable esterified starches to be used include Matsutani Yuri 8 and Food Starch NE1 manufactured by Matsutani Chemical Industry Co., Ltd., and Kemisuta 210 manufactured by Glico Foods Co., Ltd. Examples of suitable etherified starches to be used include Matsutani Yuri 2 manufactured by Matsutani Chemical Industry Co., Ltd. and Kemisuta 200 manufactured by Glico Foods Co., Ltd. Examples of suitable crosslinked starches to be used include Perfect Oamiru AC75 manufactured by Matsutani Chemical Industry Co., Ltd. and Kemisuta 420 manufactured by Glico Foods Co., Ltd. Examples of suitable oxidized starches to be used include Kemisuta 10T and Kemisuta 50H manufactured by Glico Foods Co., Ltd.

The above-described modified starches can be used solely or in combination. The amount thereof to be used is preferably 5 to 10 wt % of a frozen food, and more preferably 6 to 9 wt %. When the amount of the modified starch used is less than 5 wt % or more than 10 wt %, denaturation due to freezing tends to occur easily.

The influence of the type and the amount of modified starch to be added on the quality of frozen food will be described below.

0.5 kg of salt was added to 17 kg of walleye pollock paste, and the mixture was mashed with a food cutter. After that, 5.7 kg of trehalose, 0.5 kg of sweet cooking rice wine, 9.5 kg of almond paste and 58 kg of water were mixed therewith to prepare 91.2 kg of mixture.

The resultant mixture was divided into 16 portions (each portion: 5.7 kg). Naught to 12.5 wt % of etherified starch (Matsutani Yuri 8) was added to portions 1-6. Five or 10 wt % of non-treated potato starch was added to portions 7 and 8. Five or 10 wt % of ester if led starch (Kemisuta 210) was added to portions 9 and 10. Five or 10 wt % of crosslinked starch (Perfect Amiru AC75) was added to portions 11 and 12. Five or 10 wt % of oxidized starch (Kemisuta 10H) was added to portions 13 and 14. Five or 10 wt % of a mixture containing 50% Matsutani Yuri 8 and 50% Kemisuta 210 was added to portions 15 and 16. After kneading, 100 g of each resultant mixture was put into a cup to be heated at 90° C. for 20 minutes.

After cooling at room temperature, each mixture was frozen using a high-voltage electric-field alcohol freezing machine for 20 minutes to obtain a frozen almond-tofu-like paste at −25° C.

Each paste obtained from each of the 16 portions was defrosted 1 week after, and subjected to a physical property test and a sensory test. The results are shown in Table 1.

TABLE 1

| | | Added | | |
|---|---|---|---|---|
| | | Amount | Physical | Sensory |
| Portion | Type of Starch | (%) | Properties | Test |
| 1 | EtherifiedStarch | 0 | Unacceptable | −0.9 |
| 2 | (Matsutani Yuri | 2.5 | Unacceptable | −0.3 |
| 3 | 8) | 5.0 | Excellent | +0.5 |
| 4 | | 7.5 | Excellent | +0.6 |
| 5 | | 10.0 | Excellent | +0.4 |
| 6 | | 12.5 | Unacceptable | −0.3 |
| 7 | Non-Treated | 5.0 | Unacceptable | −0.9 |
| 8 | Potato | 10.0 | Unacceptable | −0.6 |
| | Starch | | | |
| 9 | EsterifiedStarch | 5.0 | Excellent | +0.6 |
| 10 | (Kemisuta 210) | 10.0 | Excellent | +0.5 |
| 11 | Crosslinked | 5.0 | Excellent | +0.5 |
| 12 | Starch | 10.0 | Excellent | +0.4 |
| | (Perfect Amiru | | | |
| | AC75) | | | |
| 13 | Oxidized Starch | 5.0 | Good | +0.3 |
| 14 | (Kemisuta 10H) | 10.0 | Good | +0.3 |
| 15 | Mixture | 5.0 | Excellent | +0.5 |
| 16 | (Matsutani | 10.0 | Excellent | +0.5 |
| | Yuri 8 + Kemisuta | | | |
| | 210) | | | |

According to the results, portions 1, 2 and 6 to which modified starch was not added in an amount of 5.0 to 10.0 wt %, had denaturated due to freezing, and were inferior to the non-frozen portion 1 in terms of both the physical property test and the sensory test.

Portions 7 and 8, to which potato starch, which is not a modified starch, was added, also showed inferior properties.

Non-frozen portion 1 was used as a reference for the assessment of physical properties. The assessment was carried out by a panel consisting of 10 persons, who made an evaluation as follows: Excellent: texture excels that of the reference; Good: texture is slightly better than that of the reference; Acceptable: texture is almost the same as that of the reference; and Unacceptable: texture is inferior to that of the reference. The results were derived from the most-received evaluation.

Non-frozen portion 1 was used as a reference for the sensory assessment. The judgment was carried out by a panel consisting of 10 persons, who made an evaluation as follows; +1: Excellent; 0: Similar; and −1: Inferior. The results were derived as the average points of the evaluation.

As saccharides for providing resistance to freezing, sugar, trehalose, oligosaccharide, sugar alcohol, starch syrup and reduced starch syrup can be suitably used. The amount thereof to be used is preferably 5 to 15 wt %, and particularly preferably 5 to 12 wt %. When the amount of the saccharides used is less than 5 wt % or more than 15 wt %, water tends to separate and thus the texture tends to degrade.

The influence of the type and the amount of saccharides added, on the quality of frozen food will be described below.

0.4 kg of salt was added to 15 kg of walleye pollock paste, and the mixture was mashed with a food cutter. After that, 6.2 kg of modified starch (trade name: Kemisuta 200), 0.6 kg of sweet cocking rice wine, 9 kg of sesame paste and 50 kg of water were mixed therewith to prepare 81.2 kg of mixture.

The resultant mixture was divided into 14 portions (each portion: 5.8 kg). Naught to 20 wt % of trehalose was added to portions 1-6. Five or 10 wt % of sugar was added to portions 7 and 8. Five or 10 wt % of oligosaccharide was added to portions 9 and 10. Five or 10 wt % of starch syrup was added to portions 11 and 12. Five or 10 wt % of reduced starch syrup was added to portions 13 and 14. After kneading, 100 g of each resultant mixture was put into a cup to be heated at 90° C. for 20 minutes.

After cooling at room temperature, each mixture was frozen using a high-voltage electric-field alcohol freezing machine for 20 minutes to obtain a frozen sesame-tofu-like paste at −25° C. Each paste obtained from each of the 14 portions was defrosted, and subjected to a physical property test and a sensory test. The results are shown in Table 2.

TABLE 2

| | Type of | Added | Physical | Sensory |
|---|---|---|---|---|
| Portion | Saccharide | Amount | Properties | Test |
| 1 | Trehalose | 0 | Unacceptable | −0.9 |
| 2 | | 2.5 | Acceptable | −0.2 |
| 3 | | 5.0 | Excellent | +0.8 |
| 4 | | 10.0 | Excellent | +0.5 |
| 5 | | 15.0 | Good | +0.3 |
| 6 | | 20.0 | Acceptable | −0.1 |
| 7 | Sugar | 5.0 | Excellent | +0.8 |
| 8 | | 10.0 | Excellent | +0.4 |
| 9 | Oligosaccharide | 5.0 | Excellent | +0.7 |
| 10 | | 10.0 | Excellent | +0.5 |
| 11 | Starch Syrup | 5.0 | Excellent | +0.7 |
| 12 | | 10.0 | Excellent | +0.4 |
| 13 | Reduced | 5.0 | Excellent | +0.6 |
| 14 | Starch Syrup | 10.0 | Excellent | +0.4 |

According to the results, a sample of portion 1, to which no saccharide was added, denaturated due to freezing, and in this case, the water separated and the sample did not have a soft texture at all. The sample also showed inferiority in the sensory test.

The results of portions 2-6, to which trehalose was added, were as follows. Regarding portion 2, no water separation was observed, but the sample had a watery texture and was inferior in the sensory test. Regarding portions 3-5, the samples provided excellent physical properties and had good results in the sensory test. Regarding portion 6, no water separation was observed, but the sample texture was paste-like, and was inferior in the sensory test.

In view of the results, it was judged that the suitable amount of saccharide to be added is 5 to 15 wt % of a food.

The samples of the portions 7-14, to each of which a saccharide other than trehalose was added in an amount of 5 to 10 wt %, had good results in both the physical property test and the sensory test.

Non-frozen portion 1 was used as a reference for assessing physical properties. The judgment was carried out by a panel consisting of 10 persons, who made an evaluation as follows: Excellent: texture excels that of the reference; Good: texture is slightly better than that of the reference; Acceptable: texture is almost the same as that of the reference; and Unacceptable: texture is inferior to that of the reference. The results were derived from the most-received evaluation.

Non-frozen portion 1 was used as a reference for the sensory assessment. The judgment was carried out by a panel consisting of 10 persons, who made an evaluation as follows: +1: Excellent; 0: Similar; and −1: Inferior. The results were derived as the average points of the evaluation.

Next, methods of freezing were evaluated.

0.15 kg of salt was added to 5 kg of walleye pollock paste, and the mixture was mashed with a food cutter. After that, 2 kg of trehalose, 1.5 kg of modified starch (trade name: Farinex), 0.15 kg of sweet cooking rice wine, 3 kg of peanut paste and 16 kg of water were mixed therewith to prepare 27.8 kg of mixture. The resultant mixture was divided into 5 portions (each portion: 5.56 kg). 100 g of each portion was put into a cup, which was then sealed, and then heated at 90° C. for 20 minutes.

Portion 1 was cooled in a refrigerator at 5° C. Portion 2 was frozen to −25° C., wherein duration of freezing in the range from 0 to −5° C. was regulated to be 20 minutes by controlling the temperature of a high-voltage electric-field alcohol freezing machine. Portion 3 was frozen to −25° C., wherein duration of freezing in the range from 0 to −5° C. was regulated to be 15 minutes. Portion 4 was frozen to −25° C., wherein duration of freezing in the range from 0 to −5° C. was regulated to be 10 minutes. Portion 5 was frozen to −25° C., wherein duration of freezing in the range from 0 to −5° C. was regulated to be 15 minutes by controlling the temperature of a commercial large freezer. The portions were defrosted 24 hours later and subjected to the sensory test, using the portion 1 as a reference.

The duration of freezing in the range from 0 to −5° C. was measured by a temperature sensor. In the sensory test, judgment was carried out by a panel consisting of 10 persons, who made evaluations as follows: 0: No difference from the reference; +1: Excellent compared to the reference; and −1: Inferior to the reference. The results were derived from the average points of the evaluation, as in Table 3.

TABLE 3

| | | Duration of Freezing | |
|---|---|---|---|
| | | in the Range from 0 | Sensory |
| Portion | Refrigerator | to −5° C. | Test |
| 1 | Cooling in | — | 0 |
| | Refrigerator at 5° C. | | |
| 2 | High-Voltage | 20 minutes | −0.2 |
| | Electric- | | |
| | Field Alcohol | | |
| | Freezing Machine | | |
| 3 | High-Voltage | 15 minutes | +0.4 |
| | Electric- | | |
| | Field Alcohol | | |
| | Freezing Machine | | |
| 4 | High-Voltage | 10 minutes | +0.6 |
| | Electric- | | |
| | Field Alcohol | | |
| | Freezing Machine | | |
| 5 | Large Freezer | 15 minutes | −0.3 |

It was found that high evaluation scores were obtained when the duration of freezing in the range from 0 to −5° C. was regulated to be 15 minutes or less (more preferably 10 minutes or less) using a high-voltage electric-field alcohol freezing machine. No desired effect was obtained using a large freezer, even when the duration of freezing in the range from 0 to −5° C. was regulated to be 15 minutes.

In the present invention, “high-voltage electric-field brine” refers to a method for freezing a cooked food by providing a high-voltage electric-field to brine using a brine-freezing apparatus having an electrode inserted into brine, and a high-voltage electric-field generation means. The temperature of the brine is preferably in the range from −20 to −50° C., and the electric potential of the high-voltage electric-field generation means is preferably in the range from 5 to 50 kV. The outline of the freezing apparatus to be used is as follows.

One of two electrodes of the high-voltage electric-field generation means is inserted into brine of the brine-freezing apparatus. The other electrode is not inserted into the brine of the brine-freezing apparatus, but is subjected to an insulation treatment so as not to pass a current between the above-described two electrodes. These electrodes are connected to a secondary side of a high-frequency electric-potential generation apparatus, as shown in Japanese Publication for Opposition No. 38-6106.

The brine is cooled using a freezing machine connected to the freezing apparatus, and circulated using a circulation apparatus with a drive motor in order to maintain a constant temperature in a tank containing the brine.

When installing the freezing apparatus, the high-voltage electric-field generation means and the drive motor of the circulation apparatus, glass insulation is used as a support between the floor surface and each apparatus.

An anti-freeze solution to be used for the brine is not particularly limited as long as it does not freeze at a target temperature. Examples thereof include calcium chloride, ethylene glycol, propylene glycol, ethanol, and mixtures thereof, or mixtures thereof and water. For example, a mixture of water and ethanol may be used.

An apparatus for sealing food is used in order to subject food to brine freezing and to carryout freezing and cooking simultaneously by packaging a flavoring solution together with the food.

By freezing the food with a high-voltage electric-field, the temperature of the frozen food, which is decreased during freezing, may pass through the maximum ice crystal generation range (0 to −5° C.) as fast as possible. Therefore, growth of ice crystals formed from water contained in a food material is inhibited, thereby preventing structural breakdown, and the state of the food material before freezing can be retained when defrosted.

In order to provide foods having a preferable soft texture for seniors, the amount of water to be added to the foods must be increased. Therefore, the relationship between the amount of water to be added and the quality of the foods was studied as follows.

0.2 kg of salt was added to 6 kg of Atka mackerel paste, and the mixture was mashed with a food cutter. After that, 3.6 kg of sorbitol, 3.5 kg of modified starch (trade name: Kemisuta 200) and 3.5 kg of almond paste were mixed therewith to prepare 16.8 kg of mixture.

The resultant mixture was divided into 6 portions (each portion: 2.8 kg). For portion 1, 1.51 kg of water was added to 2.8 kg of the mixture (the amount of water added: 35%). After mixing the resultant mixture again and kneading it well, 100 g of the mixture was put into a cup to be heated at 90° C. for 25 minutes.

For portion 2, 1.87 kg of water was added to 2.8 kg of the mixture (the amount of water added: 40%). For portion 3, 2.80 kg of water was added to 2.8 kg of the mixture (the amount of water added: 50%). For portion 4, 4.20 kg of water was added to 2.8 kg of the mixture (the amount of water added: 60%). For portion 5, 6.53 kg of water was added to 2.8 kg of the mixture (the amount of water added: 70%). For portion 6, 8.40 kg of water was added to 2.8 kg of the mixture (the amount of water added: 75%). Like portion 1, after mixing each resultant mixture again and kneading it well, 100 g of each mixture was put into a cup, which was then sealed, and heated at 90° C. for 25 minutes.

After cooling at room temperature, each mixture was frozen using a high-voltage electric-field alcohol freezing machine for 20 minutes to obtain a frozen almond-tofu-like paste at −25° C.

Each of the 6 portions of paste was defrosted and subjected to a physical property test and a sensory test. The results are shown in Table 4.

TABLE 4

| | Amount of | | |
|---|---|---|---|
| | Water | Physical | Sensory |
| Portion | Added | Properties | Test |
| 1 | 35% | Unacceptable | +0.1 |
| 2 | 40% | Good | +0.6 |
| 3 | 50% | Excellent | +0.9 |
| 4 | 60% | Excellent | +0.6 |
| 5 | 70% | Acceptable | +0.4 |
| 6 | 75% | Unacceptable | −0.2 |

The judgment of physical properties was carried out by a panel consisting of 10 persons, who made an evaluation as follows: Excellent: shape retention and soft texture are excellent; Good: shape retention and soft texture are good; Acceptable: shape retention and soft texture are provided; and Unacceptable: shape retention and soft texture are not attained. The results were derived from the most-received evaluation.

The judgment in the sensory test was carried out by a panel consisting of 10 persons, who made an evaluation as follows: +1: texture and flavor are excellent; 0: texture and flavor cannot be judged; and −1: texture and flavor are inferior. The results were derived from the average points of the evaluation.

According to the results, it was found that the ratio of water to be added is preferably 40 to 70 wt %.

The frozen food of the present invention may contain a flavoring material such as alcohols and soup stock. In addition to the above-described materials, the frozen food of the present invention may further contain sesame, peanut, walnut, almond, macadamia, pecan nut, hazelnut, chestnut, ginkgo nut, pistachio, pine nut, wolfberry, pumpkin seed, sunflower seed, pea, fava bean, kidney bean, black bean, adzuki bean, sweet potato, cheese, coffee, green tea, black tea, fruit juice, and extracts from seafood and meat of farmed animals and the like.

The above-described materials may be contained in the frozen food solely or in combination of two or more thereof. These materials can be preheated and/or retained in a dry state in the form of a solid, powder, paste or liquid. Examples of fruits include, but are not limited to persimmon, apple, pear, grape and plum. Fruit juice is obtained from these and other fruits.

The frozen food of the present invention may further contain soybean milk, milk, condensed milk, milk powder, coconut milk, soup (dashi-jiru), and fruit juice, for example, from carrot, Angelica keiskei, apple, grape and plum, and the like, as water.

### EXAMPLES

Hereinafter, the present invention will be specifically described by way of illustrative examples.

### Example 1

0.3 kg of salt, 5 kg of modified starch (trade name: Kemisuta 200; manufactured by Glico Foods Co., Ltd.), 0.5 kg of sweet cooking rice wine, 9 kg of almond paste, 50 kg of water and 7 kg of oligosaccharide (trade name: Nyuka Oligo; manufactured by Hayashibara Corporation) were mixed with 15 kg of chicken, and the mixture was kneaded using a silent cutter.

100 g portions of the resultant mixture were put into a 100 g cup, which was then sealed, and then heated at 90° C. for 30 minutes. After cooling, each 100 g mixture in the cup was frozen with a high-voltage electric-field alcohol freezing machine (trade name: Quick Freezer Type RQF-50; manufactured by Alpha System Corporation), whose temperature was set at −40° C. for 20 minutes (duration of freezing in the range from 0 to −5° C.: 5 minutes), to produce 850 frozen kneaded products at −35° C.

The frozen kneaded products were preserved at −35° C. for 3 or 6 months, and after that, defrosted for sampling. No denaturation due to freezing was recognized, and the kneaded products were novel foods, having a soft texture.

### Example 2

10 kg of isolated soybean protein, 0.1 kg of soybean oil, 4.0 kg of modified starch (trade name: Perfect Amiru AC75; manufactured by Matsutani Chemical Industry Co., Ltd.), 8 kg of sesame paste, 40 kg of water and 6 kg of reduced starch syrup (trade name: Amamiru HS-60; manufactured by Hayashibara Corporation) were mixed together and kneaded by a kneader.

80 g portions of the resultant mixture were put into an 80 g cup, which was then sealed, and then heated at 90° C. for 25 minutes. After cooling, each 80 g mixture in the cup was frozen by a high-voltage electric-field alcohol freezing machine (trade name: Quick Freezer Type RQF-50; manufactured by Alpha System Corporation) whose temperature was set at −40° C. for 20 minutes (duration of freezing in the range from 0 to −5° C.: 4 minutes), to produce 830 frozen kneaded products at −35° C.

The frozen kneaded products were preserved at −35° C. for 3 or 6 months, and after that, defrosted for sampling. No denaturation due to freezing was recognized, and the kneaded products had become novel foods having soft texture.

### Example 3

12 kg of walleye pollock paste, 3 kg of gluten powder, 0.4 kg of salt, 8 kg of trehalose, 5 kg of modified starch (trade name: Kemisuta 300S; manufactured by Glico Foods Co., Ltd.), 0.6 kg of sweet cooking rice wine, 15 kg of sesame paste and 50 kg of water were mixed together and kneaded by a Stephan cutter.

100 g portions of the resultant mixture were put into a 100 g cup, which was then sealed, and then heated at 95° C. for 20 minutes.

After cooling, each 100 g mixture in the cup was frozen by a high-voltage electric-field alcohol freezing machine (trade name: Quick Freezer Type RQF-50; manufactured by Alpha System Corporation) whose temperature was set at −45° C. for 20 minutes (duration of freezing in the range from 0 to −50° C.: 4 minutes), to produce 925 frozen kneaded products at −40° C.

The frozen kneaded products were preserved at −40° C. for 6 months, and after that, defrosted for sampling. No denaturation due to freezing was recognized, and the kneaded products had become novel foods having soft texture.

What is claimed is:

1. A frozen food produced by: using at least one type of protein selected from the group consisting of animal proteins and vegetable proteins, as a main raw material; adding modified starch, saccharide and water to the main raw material; kneading and heating the resultant mixture to produce a kneaded product; and subjecting the kneaded product to a high-voltage electric-field brine-freezing treatment.

2. A frozen food according to claim 1, wherein the modified starch is at least one type of starch selected from the group consisting of esterified starch, etherified starch, crosslinked starch and oxidized starch.

3. A frozen food according to claim 1, wherein the content of the modified starch is 5 to 10 wt % of the food.

4. A frozen food according to claim 1, wherein the saccharide is at least one type of saccharide selected from the group consisting of sugar, trehalose, oligosaccharide, sugar alcohol, starch syrup and reduced starch syrup.

5. A frozen food according to claim 1, wherein the content of the saccharide is 5 to 15 wt % of the food.

6. A frozen food according to claim 1, wherein the amount of the water to be added is 40 to 70 wt % of the food.

7. A frozen food according to claim 1, wherein the kneaded product further comprises a flavoring material.

8. A method for producing a frozen food, wherein at least one type of protein selected from the group consisting of animal proteins and vegetable proteins is used as a main raw material, the method comprising the steps of: adding modified starch, saccharide and water to the main raw material to be kneaded;
heating the kneaded mixture to obtain a kneaded product; and
subjecting the kneaded product to a high-voltage electric-field brine-freezing treatment.

9. A method for producing a frozen food according to claim 8, wherein the high voltage electric field brine freezing treatment is a treatment in which freezing is carried out to pass through a temperature range of 0 to −5° C. within 15 minutes and reach a temperature range of −20 to −50° C.
